(19) United States
(12) Patent Application Publication
(10) Pub. No.: US 2006/0028528 A1
(43) Pub. Date: Feb. 9, 2006

(54) Interchangeable module for a portable printer and system for operating the same

(75) Inventors: Gregory Klein, Newport, RI (US); Michael L. Lamontagne, Johnston, RI (US); David A. Langevin, Warwick, RI (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: ZIH Corp.

(21) Appl. No.: 11/190,632

(22) Filed: Jul. 27, 2005

Related U.S. Application Data
(60) Provisional application No. 60/592,110, filed on Jul. 29, 2004.

(51) Int. Cl. B41J 3/36

(52) U.S. Cl. 347/109

(57) ABSTRACT

A printer that includes a core printer assembly which includes subassemblies capable of printing on media, and a modular assembly of additional electronic devices that supplement to core printer operation, such as different card readers or wireless communication devices. The core printer includes a main circuit board that is connected to a module circuit board that is configured to support the additional electronic devices. The connection is a single multiple-pin connector that allows easy exchange of different module circuit boards supporting different electronic devices during assembly. The module circuit board and the additional electronic devices are all contained within a modular component housing mateable with the rest of a housing supporting the core printer assemblies in a semi-permanent configuration for a finished look. The module circuit board may include a UART that is configured to buffer and control information flow between multiple electronic devices and the main circuit board.

### CROSS-REFERENCE TO RELATED APPLICATIONS

The present application claims priority from U.S. Provisional Application No. 60/592,110 entitled “Interchangeable Module for a Portable Printer and System for Operating the Same” filed on Jul. 29, 2004, the contents of which are incorporated herein by reference.

### BACKGROUND OF THE INVENTION

1. Field of the Invention

The present invention involves the combination of various interchangeable electronic devices with a core unit of a printer, and in particular to the use of a separate module that is customizable during assembly to include selected electronic devices which are recognizable by the core unit.

2. Description of Related Art

Information cards have become increasingly important in recent times due to the increase in cashless transactions and the need for greater corporate, home and governmental security. Information cards are typically some type of plastic card that contains and conveys information in the form of indicia, or as encoded information. For instance, information cards include magnetic stripe cards, such as credit cards and banking cards, that can be “swiped” past a reader to convey the information encoded in the magnetic stripe. Barcode cards bear barcode indicia that can be scanned by a laser scanner, or other scanning device, to convert the visual indicia of the barcode into digital information. In addition to barcodes, cards may include other indicia such as fluorescent text, holograms, or encode pixilated images that can be read with appropriate readers. Smart cards include cards having some type of electronic component, such as a radio frequency identification (RFID) tag that responds to a radio emission with its own emission of information stored in memory. Other types of smart card are also used, such as cards having circuitry and contacts (e.g., gold plated contacts) which are contacted by the smart card reader for reading.

One use of these cards is in cashless transactions, such as at a restaurant. After completion of dining, a waitperson brings a bill to the table. Upon noticing the bill, the customer either pays in cash or provides a credit or bank card. The waitperson must retrieve the credit or bank card and return to a point-of-sale terminal to swipe the card (if it is a magnetic stripe card). Once the transaction is approved at the point-of-sale terminal, a receipt is printed out bearing the transaction amount and a signature line. The waitperson then returns to the table and drops off the card and receipt for signing by the customer. The customer signs the receipt to acknowledge payment and is then free to depart. As is evident from the description, the process of conducting a credit card transaction is relatively time consuming when compared to a cash transaction.

Wireless point of sale terminals have been developed in an effort to mediate the delays of paying by credit or bank card. For example, U.S. Patent Application Publication No. 20020077974 to Ortiz (“Ortiz”) discloses a hand held device 56 that includes a touch screen display 52 and that is configured to read a card 50 and transmit transaction information over a wireless network 70 to a printing station 72, as shown in FIG. 4 of Ortiz. During use the credit card is inserted into the hand held device which reads data from the credit card and transmits this data wirelessly through a local server to a clearinghouse server. If the clearinghouse server approves the transaction, the hand held device wirelessly transmits details to the printer for printing of a receipt. The touch screen display may also be configured to record a signature of the cardholder. Notably, the hand held device disclosed by Ortiz eliminates the need to return with the card to a point of sale terminal. However, the printing station may also be at an inconvenient location for the waitperson and require additional trips. Further, with the advent of different types of transaction cards, such as smart and RFID cards, the problem may still arise that the hand held device will only be able to recognize one type of card.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a perspective view of a printer of one embodiment of the present invention;

FIG. 2 is a perspective view of the printer of FIG. 1 with a media cover in an open position;

FIG. 3 is a perspective view of a modular component cover and main circuit board of the printer of FIG. 1;

FIG. 4 is a perspective view of contents of a base portion of the printer of FIG. 1;

FIG. 5 is an exploded view of a print head, drive and latching assemblies of the printer of FIG. 1;

FIG. 6 is a perspective view of a media support assembly of the printer of FIG. 1;

FIG. 7 is a perspective view of the media support assembly of FIG. 6;

FIG. 8 is another perspective view of the media support assembly of FIG. 6 containing a roll of media;

FIG. 9 is an exploded view of the media support assembly of FIG. 6;

FIG. 10 is a perspective view of the print head assembly of FIG. 5;

FIG. 11 is a sectional view of the print head assembly of FIG. 5;

FIG. 12 is a partial view of a latch member of a latch assembly of the printer of FIG. 1;

FIG. 13 is a perspective view of the print head assembly of FIG. 5 and the latch assembly of FIG. 12;

FIG. 14 is an elevation view of the latch member of FIG. 12;

FIG. 15 is a schematic of a main circuit board and an interchangeable module circuit board of the printer of FIG. 1;

FIG. 16 is another schematic of the circuit boards shown in FIG. 15;

FIG. 17 is a schematic of a main circuit board and a module circuit board of another embodiment of the present invention;

FIG. 18 is a schematic of a main circuit board and a module circuit board of another embodiment of the present invention; and

FIG. 19 is a flow chart of operation of a smart card interface of the main circuit board shown in FIGS. 16, 17 and 18.

### DETAILED DESCRIPTION OF THE INVENTION

The present invention meets the above needs and achieves other advantages by providing a printer that includes a core printer assembly which includes subassemblies capable of printing on media, and a modular assembly of additional electronic devices that supplement to core printer operation, such as different card readers or wireless communication devices. In particular, the core printer includes a main circuit board that is configured to connect to, and communicate with, a module circuit board that is configured to support the additional electronic devices. In one aspect, the connection is through a single multiple pin connector that allows easy exchange of different module circuit boards supporting different electronic devices during assembly. In another aspect, the module circuit board and the additional electronic devices are all contained within a modular component housing which is configured for mating with the rest of a housing supporting the core printer assemblies in a semi-permanent configuration giving a finished look to the printer. In still another aspect, the module circuit board may include a UART that is configured to buffer and control information flow between multiple electronic devices and the main circuit board so as to allow the use of different electronic devices. In this manner, multiple types of card readers, such as magnetic strip, barcode and smart card readers can all be employed on the same printer and also multiple types of other electronic devices such as bar code reader, RFID encoder/readers, RF transmitter/receiver, etc., even when the bandwidth of the connection between the circuit boards is relatively limited.

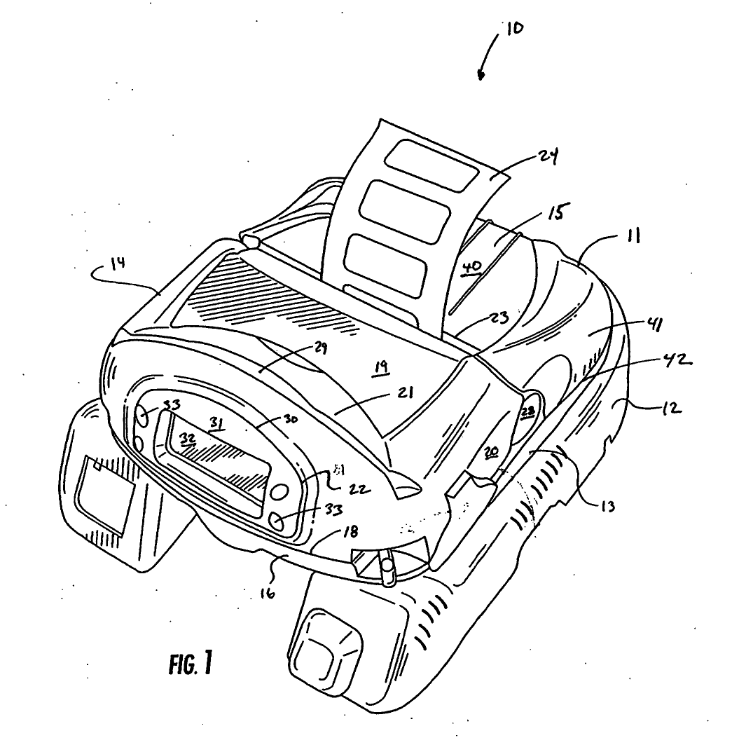

A handheld printer 10 of one embodiment of the present invention is shown in FIGS. 1-16. Generally, the printer includes a rounded, rectangular housing 11 that can be supported within a cradle 12, as shown in FIG. 1. The housing has three main sub-portions, including a base 13, a modular component cover 14 and a media supply lid or cover 15.

Various aspects of the printer illustrated in FIG. 1 are described in greater detail in the following patent applications which have been filed concurrently herewith and are hereby incorporated herein in their entirety by reference, including:

U.S. Provisional Application No. 60/592,490 to Horrocks, et al., filed on Jul. 29, 2004 and entitled SYSTEM AND METHOD FOR PROVIDING A PORTABLE PRINTER CAPABLE OF ALTERING THE ORIENTATION OF INFORMATION DISPLAY ON AN ASSOCIATED PRINTER DISPLAY;

U.S. Nonprovisional application Ser. No. 10/901,883 to Lyman, et al., filed on Jul. 29, 2004 and entitled PRINTER ASSEMBLY AND METHOD OF USING THE SAME;

U.S. Nonprovisional application Ser. No. 10/901,637 to Lyman, et al., filed on Jul. 29, 2004 and entitled DOCKING STATION AND ASSOCIATED METHOD FOR DOCKING A PORTABLE PRINTER;

U.S. Nonprovisional application Ser. No. 10/901,718 to Beck, et al., filed on Jul. 29, 2004 and entitled UNIVERSAL CARD READER APPARATUS AND METHOD; and

U.S. Nonprovisional application Ser. No. 10/901,686 to Beck, et al., filed on Jul. 29, 2004 and entitled PRINTER CABLE AND ASSOCIATED STRAIN RELIEF COLLAR FOR CREATING A RUGGEDIZED CONNECTION FOR AN ELECTRICAL TERMINAL OF A PRINTER AND ASSOCIATED METHODS THEREFOR.

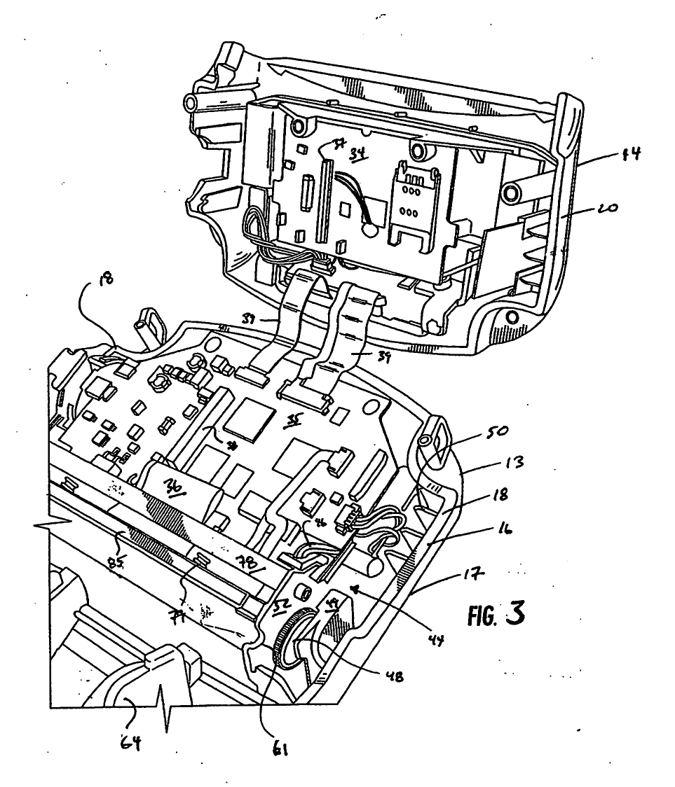

The base 13 has a rectangular shape with a wall structure 16 extending upwards from a bottom surface 17 to support and contain various electronic and mechanical assemblies of the printer 10. The wall structure 16 ends in a free edge 18 that extends continuously around the rectangular shape of the base 13 and is configured to mate with the card processor cover 14 and the media supply cover 15, as shown in FIG. 3

The modular component cover 14 includes a deck portion 19, a pair of sidewalls 20, an information card receiving portion 21 and a display portion 22. The deck portion 19 is a relatively planar surface that extends between the pair of sidewalls 20 and defines one edge of a media dispensing opening 23 through which a strip of media 24 extends, as shown in FIG. 1. Each of the sidewalls 20 includes a free edge that is configured to mate with the media supply cover 15 and with the free edge 18 of the base wall structure 16. A portion of the free edge of one of the sidewalls 20 has an arc shape to provide clearance (along with an arc shape defined by the media supply cover 15 and a semi-circle defined by the free edge 18 of the base wall structure 16) for a latch button 28 used to open the media supply cover 15.

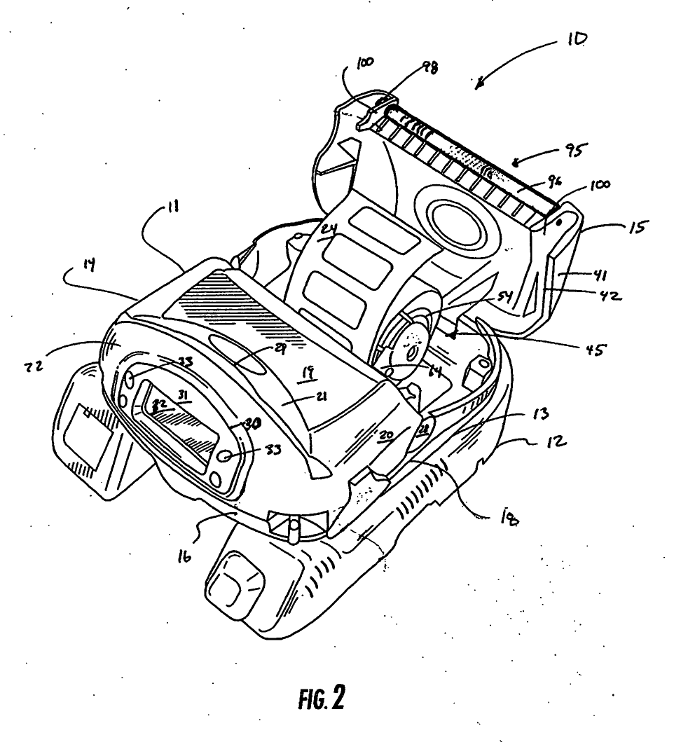

Abutting the deck portion 19 is the information card receiving portion 21, as shown in FIGS. 1-2. The information card receiving portion 21 extends upwardly to a peak and downwardly transitioning into the display portion 22. Defined at the peak of the information card receiving portion 21 is a card receiving slot 29 that is sized and shaped to allow a magnetic strip information card (such as a credit card) to be “swiped” therethrough for reading and decoding of information recorded thereon.

Other types of information card could also be extended through the card receiving slot 29 for reading, including various bar-coded cards or contact and non-contact smart cards. Further, any media, such as an envelope, slip of paper, etc., having a magnetic strip, barcode or smart card features could be slid and read via the slot. The display portion 22 of the card processor cover 14 defines a display opening 30 through which extends a display unit 31, as shown in FIGS. 1 and 2. The display unit 31 includes a display screen 32 and four buttons 33 that communicate information on operation of the printer 10 and record inputs and selections by the operator.

The media supply cover 15 includes its own deck portion 41 and wall structure 42, as shown in FIGS. 1 and 2. The deck portion 41 is a relatively flat, planar surface that is coextensive with the deck portion 19 of the modular component cover 14. The deck portion 41 defines an edge of the media dispensing opening 23 opposite the edge defined by the deck portion 19 of the modular component cover 14. Optionally, the deck portion may be constructed of a transparent or translucent material to facilitate visibility of the media roll in anticipation of replacement of a spent or nearly spent media roll. A free edge of the wall structure 42 is configured to mate with a portion of the free edge of the sidewalls 20 of the modular component cover 14 and a portion of the free edge 18 of the wall structure 16 of the base 13 to form the closed housing 11 shown in FIG. 1.

Now that the external aspects of the printer 10 of the illustrated embodiment have been described, including the structure of its housing 11, attention will be turned to the contents of the housing, including the various assemblies that enable the core printing functions.

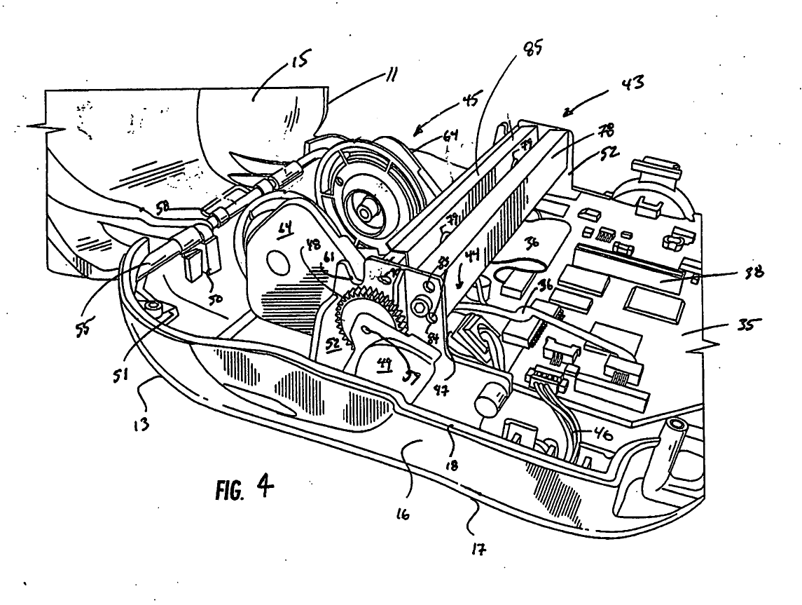

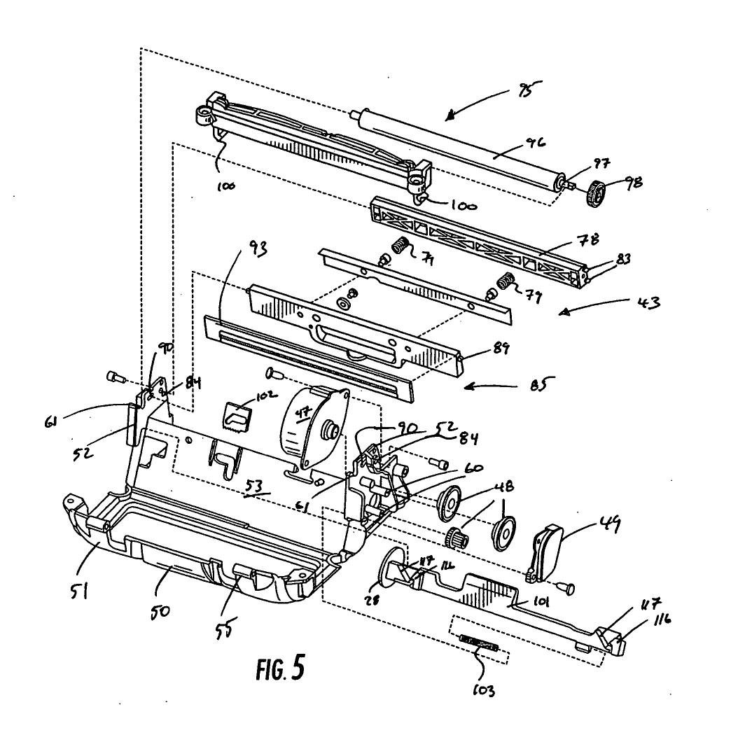

Referring now to FIG. 4, the base 13 of the housing 11 supports a main circuit board 35, a print head assembly 43, a drive assembly 44, a media support assembly 45 and a latch assembly 62. The print head assembly 43, the drive assembly 44, the media support assembly 45 and the latch assembly 62 are each mounted on a frame 50, as shown in FIGS. 4 and 5.

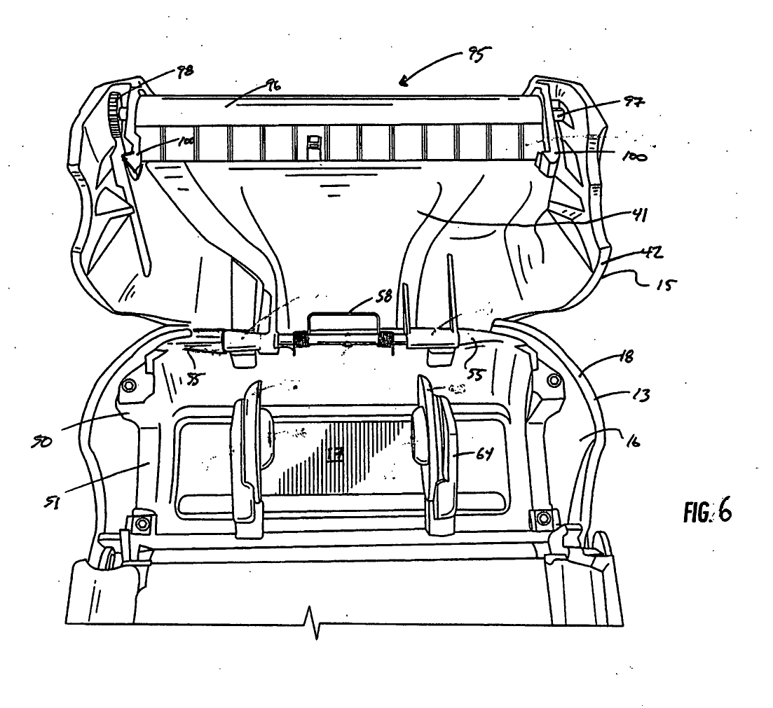

The frame 50 is supported within, and attached to, the base 13 of the housing 11. The frame 50 includes a hinge portion 51, and one or more side flanges 52 and a divider wall 53. The hinge portion 51 generally has a rectangular frame shape with rounded edges so as to fit in the rounded shape in an area of the base 13 housing a media supply roll 54. The hinge portion 51 and media supply cover 15 at their intersection form a hinge assembly 55 to allow rotation between the base and the cover. In addition, the hinge assembly includes a torsion spring 58 which biases the media supply cover 15 into its open position with respect to the base 13, as shown in FIG. 6. Other biasing devices could also be employed to facilitate opening of the cover 15, such as hydraulics, compressed air or solenoids.

The side flanges 52 of the frame 50 extend upwards from the base 13 of the housing 11 on the lateral sides of the base. The divider wall 53 extends between the side flanges 52 and generally partitions the base 13 into two portions, one portion having the media support assembly 45 and the other portion containing the main circuit board 35. Both the flanges 52 and the divider wall 53 have structure that provides support for the assemblies 43, 44 and 45, as will be described in more detail below.

The main circuit board 35 includes a processor and other electronic components for controlling printer operation. A pigtail wire 46 connects the main circuit board 35 to the drive assembly 44 and ribbon cables 36 connect the main circuit board to the print head assembly 43. Ribbon cables 39 connect the display unit 31 to the main circuit board. These connections enable the main circuit board 35 to communicate with, and control, the print head assembly 43, the drive assembly 44 and the display unit 31. Essentially, then, the main circuit board controls the core printing operations of the handheld printer 10.

The drive assembly 44 includes a motor 47, several drive gears 48 and a gear cover 49, as shown in FIGS. 4 and 5. The motor 47 is mounted to the inside surface of one of the side flanges 52 and has a drive shaft 59 extending through an opening in the side flange to mesh with the drive gears 48. The drive gears are rotatably mounted on pegs 60 extending from the opposite side of the side flange, and mesh with each other so as to be driven by the motor 47. The gear cover 49 is mounted over a portion of the drive gears 48 so as to protect the drive gears during operation.

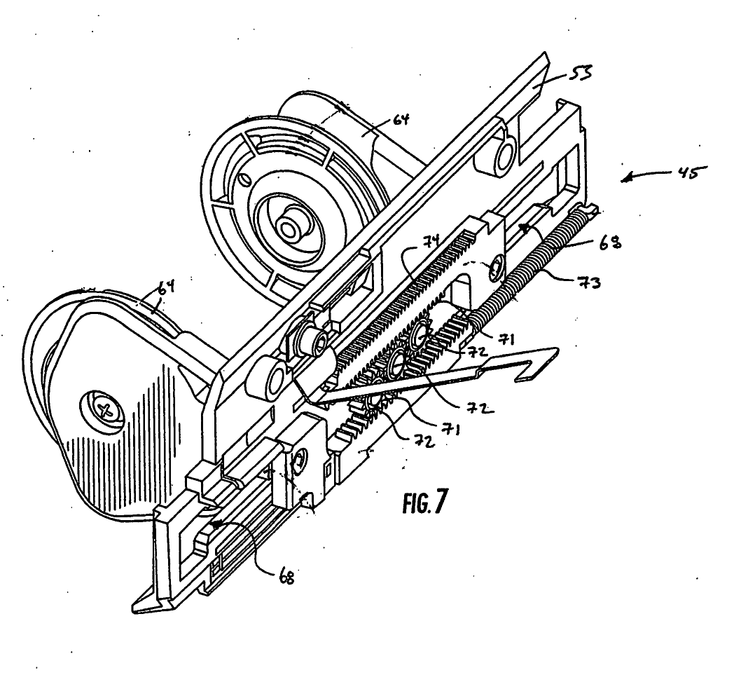

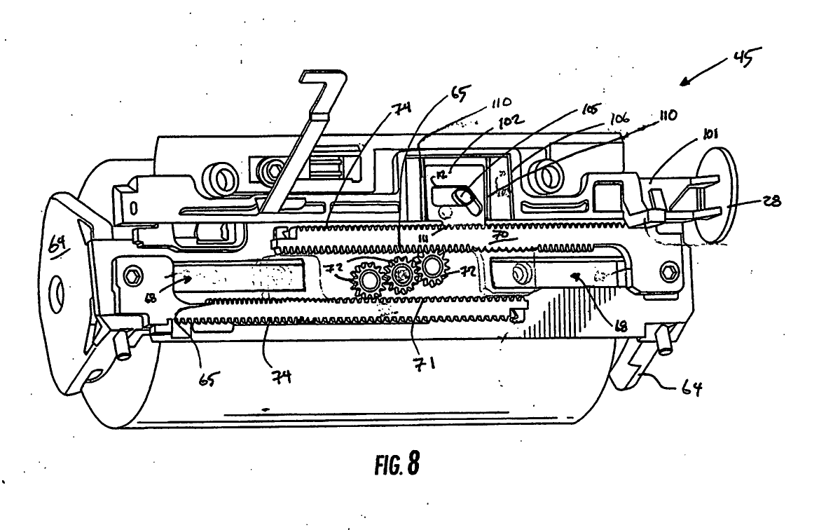

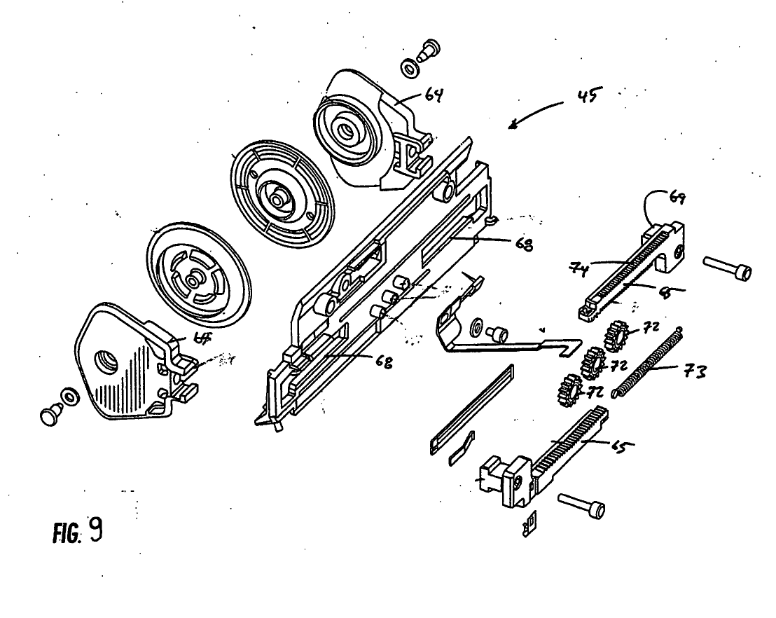

The media support assembly 45 includes a pair of media support flanges 64, a pair of racks 65, several pinions 72 and a tension spring 73, as shown in FIGS. 6-9. The media support flanges 64 are positioned opposite each other so as to be able to grip the media supply roll 54 when urged together. As shown in FIG. 9, a portion of each of the media support flanges is configured to extend through one of a pair of guide slots 68 defined in the divider wall 53 and connect to a respective one of the racks 65, as shown in FIGS. 7 and 8.

Each of the racks also includes a pinion face 71 that has teeth shaped to mesh with the teeth of one of the pinions 72. The pinions 72 are rotatably mounted on the divider wall 53 and are positioned between the pinion face 71 on the racks 65 so as to communicate sliding motion between the racks. The tension spring 73 extends from a free end of one of the racks 65 to an attachment on the divider wall 53 so as to bias the racks, and the media support flanges 64 attached thereto, together to embrace a media supply roll 54, as shown in FIGS. 2 and 8. Each of the racks 65 also includes a locking face 74 positioned opposite the pinion face 71 for interacting with the latch assembly 62 to lock the racks in place, as will be described in more detail below.

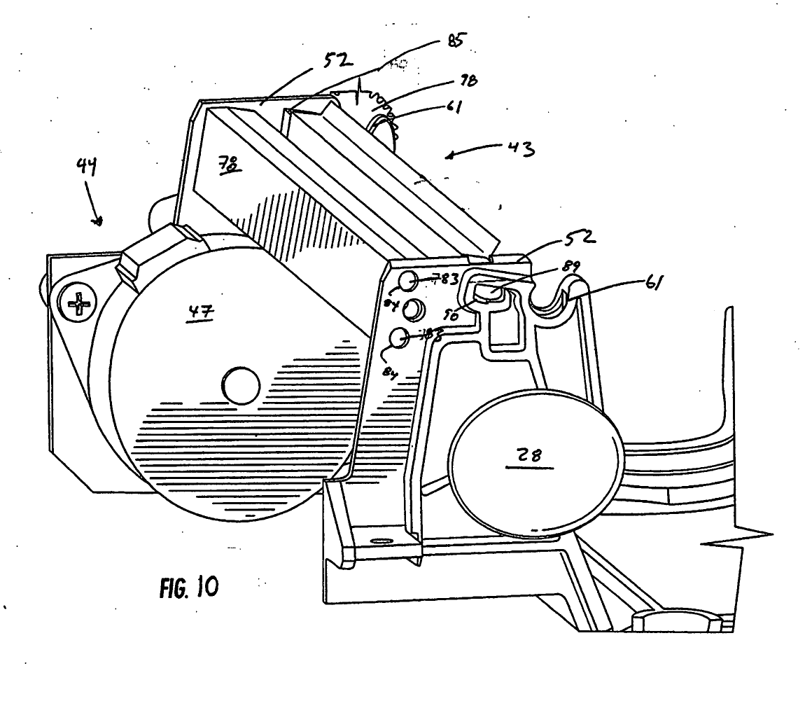

The print head assembly 43 includes a mounting bar 78, one or more springs 79 and a thermal printing head 85, as shown in FIG. 5. The mounting bar 78 has an elongate rectangular shape and includes a pair of mounting pegs 83 on its ends. Each of the side flanges 52 defines a pair of mounting openings 84 sized and positioned to receive the mounting pegs 83 on the ends of the mounting bar 78, as shown in FIG. 10. The springs 79 are attached at one end to the mounting bar 78 at spaced positions. The springs 79 are coil springs that extend toward the media support assembly 45 and attach at their other ends to the thermal printing head 85.

Similar to the mounting bar 78, the thermal printing head 85 has an elongate rectangular shape that extends between the side flanges 52. Also, the thermal printing head 85 includes one of a pair of elliptical mounting pegs 89 at each of its ends. Defined in the side flanges 52 are slots 90 sized to receive a minor width of each of the elliptical mounting pegs 89. The length of the slots 90 allow sliding of the elliptical mounting pegs 89 therein, and hence movement of the thermal printing head 85 with respect to the side flanges 52 and the mounting bar 78. The springs 79 bias the thermal printing head 85 against the media strip 24 and, along with the slots 90 and mounting pegs 89, allow the thermal printing head to shift with changing thicknesses of the media strip 24. The thermal printing head includes a burn line 93 that makes contact with the media strip 24 and imprints thereon.

A platen assembly 95 of the printer 10 is shown in FIGS. 5 and 6, and includes a platen bar 96, a platen shaft 97 and a platen gear 98 and is supported by the media supply cover 15. In the illustrated embodiment, the platen bar 96 is an elongate, cylindrical bar that includes a rubber or polymeric coating to facilitate gripping of the strip of media 24. The platen bar 96 extends between a pair of spaced flanges 100 defined on opposite sides of the media supply cover 15 within its wall structure 42. The flanges 100 may also be defined as part of a support structure secured to the media supply cover 15. The platen shaft 97 extends from the ends of the platen bar 96 and through corresponding openings defined in the flanges 100 so as to rotatably support the platen bar and shaft. On one end, the platen shaft 97 supports the platen gear 98, which is recessed between the adjacent one of the flanges 100 and the wall structure 41, as shown in FIG. 6.

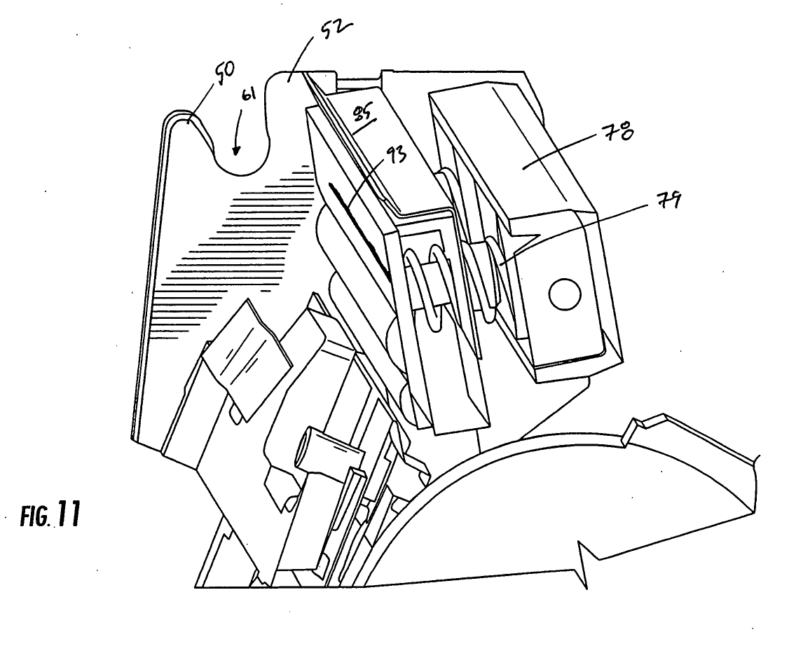

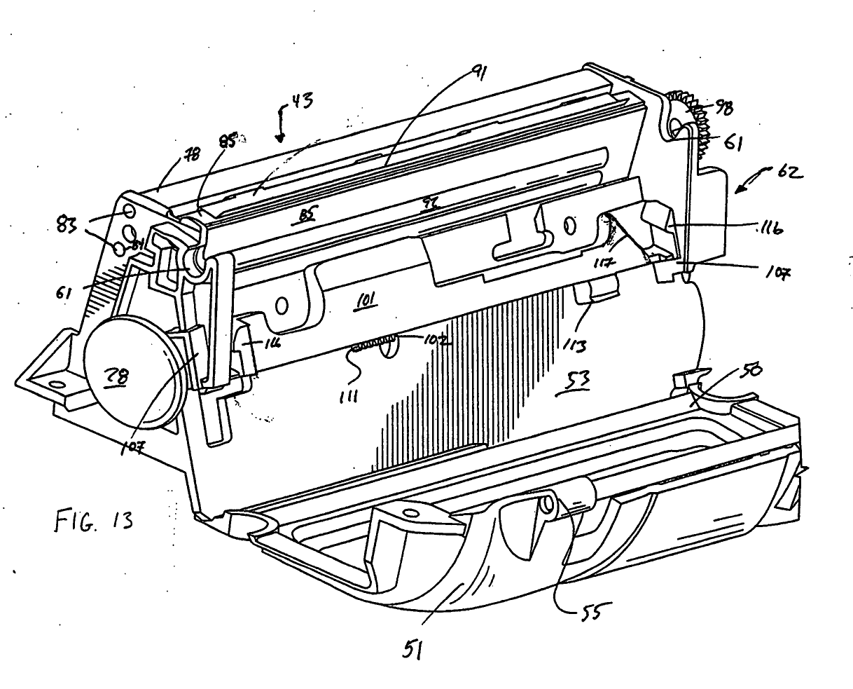

The side flanges 52 of the frame 50 define a pair of journal notches 61 that have a circular inner portion and a flared outer portion, as shown in FIGS. 11 and 13. The journal notches 61 are sized and shaped to receive ends of the platen shaft 97 when the media supply cover 15 is in a closed position.

When the media supply cover 15 is in the closed position, the platen assembly 95 cooperates with the drive assembly 44 and the media support assembly 45 to draw the strip of media 24 across the thermal printing head 85 of the print head assembly 43 for printing. In particular, when the media supply cover 15 is closed, the platen bar 96 is positioned against the burn line 93 of the thermal printing head 85 and the platen gear 98 meshes with the top-most one of the drive gears 48. The strip of media 24 extends between the platen bar 96 and the burn line 93. The thermal printing head 85 is urged against the strip of media 24 and the platen bar 96 by the springs 79. During advancement of the strip of media 24, the motor turns the platen bar 96 via the platen gear 98 which draws the strip of media off of the media supply roll 54 due to the friction between the platen bar 96 and the strip of media which is pressed against the printing head 85.

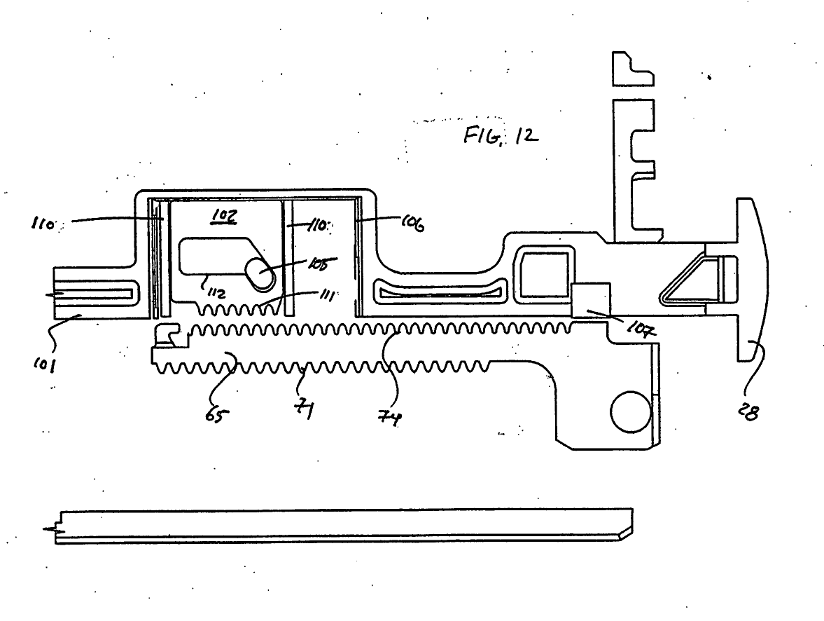

The latch assembly 62 includes a latch member 101, a locking plate 102 and a latch spring 103, as shown in FIG. 5. The latch member 101 has an elongate shape with the latch button 28 extending from one end. The latch member is slidably supported channels 107 that are defined in the side flanges 52 of the frame 50, as shown in FIGS. 12 and 13.

On a side of the latch member 101 facing the divider wall 53, the latch member includes a tracking peg 105 that is positioned in a rectangular recess 106, as shown in FIG. 12. The rectangular recess 106 is sized to extend around a pair of vertically oriented locking plate guides 110 that extend outward from the divider wall 53, as shown in FIG. 5. The locking plate guides 110 are parallel and spaced apart from each other about the same distance as the width of the locking plate 102, as shown in FIG. 12. The locking plate 102 has a thin, rectangular shape and includes a row of teeth 111 extending along one edge. An engagement opening 112 defined in the locking plate includes an angled portion and a straight portion which are sized to extend around the tracking peg 105.

As assembled, the latch member 101 extends closely along the divider wall 53 and the rectangular recess 106 is positioned over the locking plate guides 110, as shown in FIG. 13. The locking plate 102 extends between the locking plate guides and the tracking peg 105 extends into the engagement opening 112. The shape of the engagement opening causes the teeth 111 of the locking plate 102 to be urged into and out of engagement with teeth on the locking face 74 of the adjacent one of the racks 65. In particular, sliding of the latch member 101 (by depressing of latch button 28) moves the tracking peg 105 within the engagement opening 112 from the angled portion (as shown in FIG. 12), where the locking plate 102 is disengaged from the locking face 74 of the rack, to the straight portion, where the locking face of the rack is engaged by the teeth 111 of the locking plate. When the locking face 74 and teeth 111 are engaged, motion of the two racks 65 is inhibited, holding the media supply roll 54 in place when the media supply cover 15 is in the closed position.

Referring again to FIG. 9, the latch member 101 includes a spring flange 113 for engaging the latch spring 103. The latch spring is preferably a compression spring and is positioned between the spring flange 113 and the adjacent one of the side flanges 52 so that the latch member 101 is biased to urge the button 28 outwards, i.e., in the left-handed direction on FIG. 5.

Free ends of the flanges 100 on the media supply cover 15 are hook shaped so as to engage a pair of catch hooks 116 defined on the latch member 101 to hold the media supply cover 15 in the closed position. Engagement of the latch member with the flanges 100 when the media supply cover is closed holds the latch member short of its left-most position, at which position the locking plate 102 is biased toward the engaged or locking position. Therefore, when the media supply cover 15 is closed, the locking plate 102 inhibits movement of the racks 65 which, in turn, locks the media support flanges 64 about the media supply roll 54. Conversely, opening of the lid 15 disengages the flanges 100 and the catch hooks 116 of the latch member 101, allowing the latch member to be biased to the outermost position, which disengages the locking plate 102 from the locking face 74.

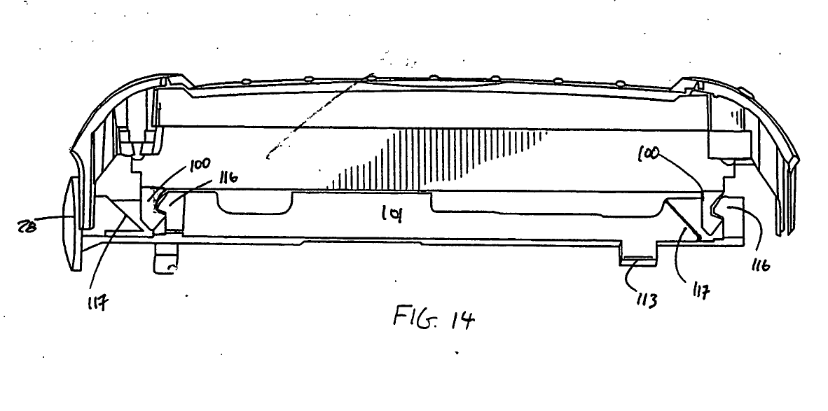

In addition to locking and unlocking the media support assembly 45, the latch assembly is configured to enable one-handed opening of the media supply cover 15. As shown in FIG. 14, the side of the latch member 101 facing the media support assembly 45 also includes a pair of outwardly sloped cam surfaces 117. As described above, the catch hooks 116 are configured to engage the similarly shaped flanges 100 on the media supply cover 15 and, under the bias from the latch spring 103, hold the cover shut until the bias from the latch spring is overcome by depressing the latch button 28. The sloped cam surfaces 117 are configured to engage the flanges 100 with further depression of the latch button 28 and to urge the media supply cover 15 upwards as an aid to the torsion spring 58 which completes opening of the cover in a subsequent stage.

Having described the operation of the print head assembly 43, the drive assembly 44, the media support assembly 45, the latch assembly 62 and the platen assembly 95, and their ability to supply the media strip 24, hold and lock in place the media supply roll 54 and coordinate unlocking of the media supply roll with one-handed, biased opening of the media supply cover 15, attention is now turned to how the present invention allows interchangeability of various additional electronic functional modules. It should be noted that although particular configurations of electronic devices are described herein, the present invention should not be considered limited to only the illustrated combinations. Rather, the present invention facilitates customized selection, installment and recognition by the main circuit board 35 of different electronic devices, as well as communication between the different electronic devices and the main circuit board, so as to meet the customized demands of the operator of the handheld printer 10.

Referring now to FIG. 3, the contents of the modular component cover 14 are revealed including the display unit 31 and an interchangeable module circuit board 34. The display unit is supported by the modular component cover 14 and is connected to the main circuit board 35 by ribbon cables 39 allowing communication between the display unit and the main circuit board. As noted above, the display screen 32 of the display unit extends through the display opening 30 defined in the modular component cover 14. As a result, the display unit 31 extends at roughly the same angle as the display portion 22 of the modular component cover 14.

The interchangeable module circuit board 34 is positioned adjacent to the display unit 31, but extends at an angle paralleling the deck portion 19 of the modular component cover 14, as also shown in FIG. 3. When the base 13 and modular component cover 14 are assembled, the main circuit board 35 and interchangeable module circuit board 34 are positioned in a compact, parallel arrangement. It should be noted that although the preferred positioning of the module circuit board 34 and electronic devices and peripherals operated therewith is in the modular component cover 14 separate from the remainder of the housing 11, the module circuit board and electronic devices could be distributed within other portions of the housing which are separable or not separable from the remainder of the housing.

Supported on the interchangeable circuit board 34 is a multiple pin male connector 37 that is configured for insertion into a multiple pin female connector 38 supported on the main circuit board 35. This connection is facilitated by the generally parallel assembled configuration of the circuit bards 34, 35 described above. Advantageously, the multiple pin male and female connectors 37, 38 and positioning of the boards 34, 35 facilitate a simple, single-location attachment of the interchangeable circuit board 34 and the main circuit board 35, thereby allowing easy interchanging of circuit boards, and different modular component covers, having different functions and devices with the main circuit board and core printer assembly.

In this manner, non-core functions of the handheld printer 10 can be customized by selection of different types of modular component cover 14 housing different combinations of electronic devices. Generally, the modular component cover 14, module circuit board 34 and the electronic devices operated therewith, are also preassembled so that the connection need only be made between the male and female connectors 37, 38, and the modular component cover 14 and base 13 to complete customization. Of course it is also possible that the printer 10 could be assembled in different orders and stages, or all at one time, and still be within the purview of the present invention.

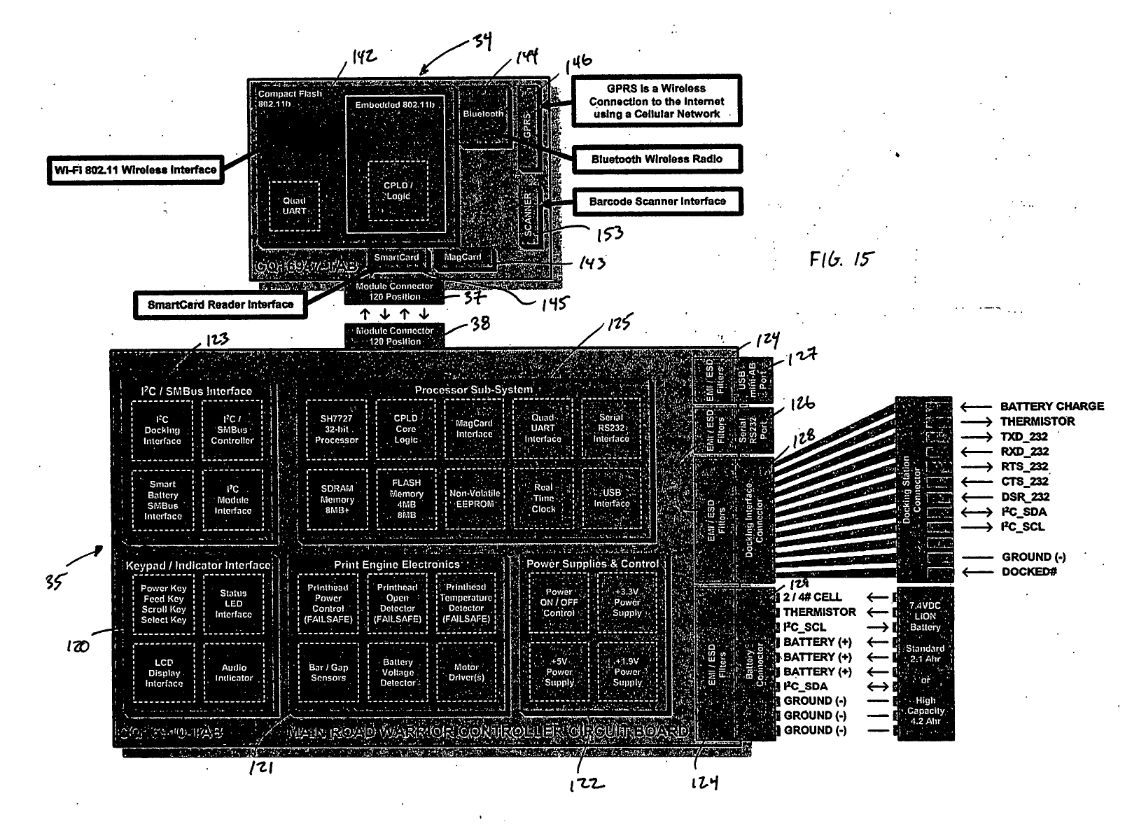

The connection and some of the functions of the two circuit boards 34, 35 are depicted schematically in FIG. 15. In particular, the main circuit board includes a plurality of logic blocks representing hardware, software, firmware, or combinations thereof, configured to produce various functions, including a keypad interface 120, a print engine 121, a power supply control 122, a bus interface, various filters 123 and a processor subsystem 125.

Among the core printer operations, the keypad interface 120 is configured to record feedback from the buttons 33 (e.g., power, feed, scroll and select buttons), determine the status of the display screen 32, operate graphics on the display screen 32 and provide an audio signal correlated with different events, such as a paper jam. The print engine 121 is configured for controlling power to the print head 85, detecting opening of the print head assembly 43, detecting print head temperature, sensing opening of the media supply cover 15, detecting battery voltage and operating the drive assembly 44. The power supply control 122 is configured to switch the power supply on and off and operate different voltage power supplies ranging from 1.9 V, to 3.3 V to 5 V. The bus interface is configured to allow attachment and communication of various docking modules. The filters 124 are configured to filter information from various connections, such as different types of ports (serial 126 and USB 127), a docking station connector 128 and a battery connector 129.

The processor subsystem 125 includes several core functions, and other functions that facilitate the modularity of the printer 10 of the present invention. The processor subsystem includes a microprocessor 130 for executing code, memory modules 131 including flash and SDRAM memory, programmable memory 132, a clock 133, a USB interface 134 (for communicating with the USB port 127) and a serial interface 135 (for communicating with the serial port 126).

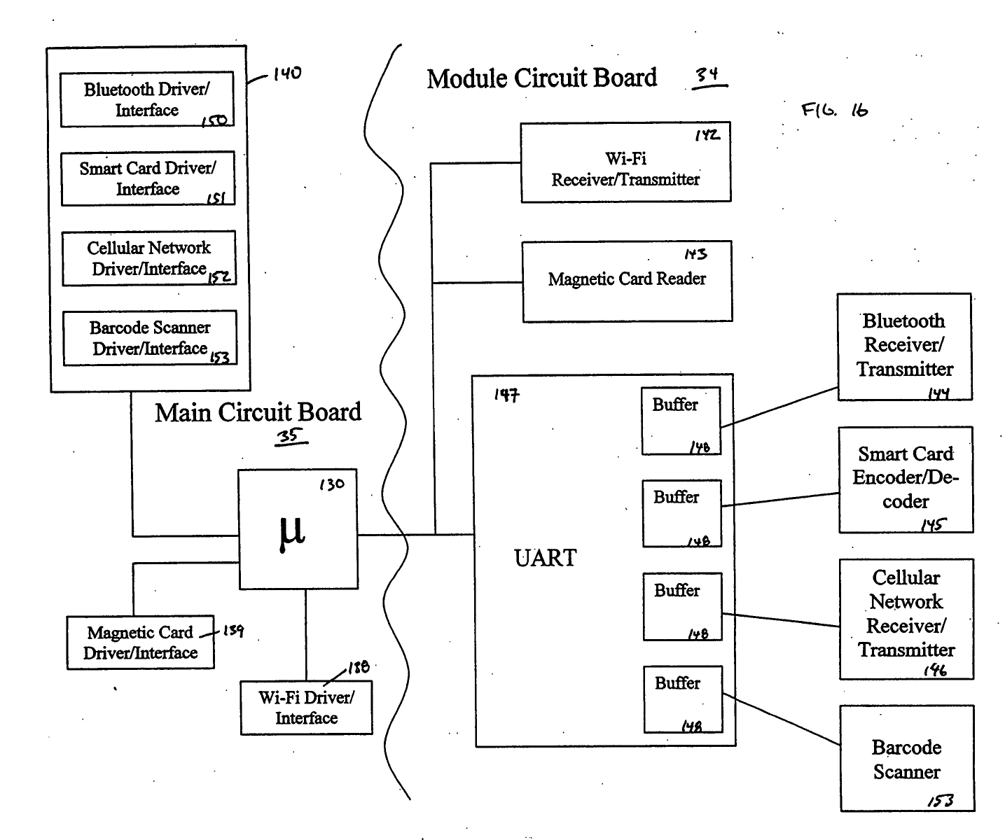

In one embodiment of the present invention, communication between the microprocessor 130 and the interchangeable module circuit board 34 via the male and female connectors 37, 38 is facilitated by a Wi-Fi core logic interface 138, a magnetic card reader interface 139 and a UART interface 140, as shown in FIGS. 15 and 16. Operating within, or through, the UART interface 140, may be the Bluetooth driver/interface 150, the smart card driver/interface 151, the cellular network driver/interface 152 and the barcode scanner driver/interface 153. While not shown, an RFID encoder/reader could also be included and interfaced via the UART or its own separate connection. As can also be seen in FIGS. 15 and 16, the interchangeable module circuit board 34 has several electronic devices selected to complement the core printer operations including a Wi-Fi receiver/transmitter 142, a magnetic card reader 143, a Bluetooth receiver/transmitter 144, a smart card encoder/decoder 145, a cellular network receiver/transmitter 146 and a barcode scanner 149.

The terms “interface” and “driver” are used interchangeably herein to denote logic, code, circuitry or other electronic, firmware or software, application, that facilitates communication with, and control of, the denoted electronic device by the microprocessor 130 and/or other aspects of the main circuit board 35. Further, with reference to the various modularly added devices resident in the modular component cover 14, the terms receiver, reader, transmitter, encoder, decoder, scanner, etc., are used to refer to the more common operations of each of the devices, but each of the devices included in the modular circuit board 34 should be considered capable of the other functions described for other devices herein, and/or additional functions known to those of skill in the art now and in the future. For example, the smart card encoder/decoder could also be a transmitter configured to transmit to a non-contact smart card and receive data transmitted from the non-contact smart card.

Communication with the processor subsystem 125 and the various devices of the modular circuit board 34 in the present invention can be accomplished through a direct connection, such as via selected pins of the male and female multiple pin connectors 37, 38, and the cables connected thereto. In addition, or alternatively, the module circuit board 34 may include a UART 147 which is configured to manage a serial or relatively narrow band connection allowing attachment of several devices without requiring dedicated lines for each. For example, as shown in the embodiment of FIG. 16, the UART includes several buffers 148 which allow temporary storage of data communicated from the Bluetooth reader receiver/transmitter 144, the smart card encoder/decoder 145, the cellular network receiver/transmitter 146 and the barcode scanner 149.

In addition to storing the data, the UART 147, along with the UART interface 140, includes logic configured to selectively supply the data from the various devices to the processor 130, such as through the use of hierarchical interrupts. The UART 147 and UART interface 140 are configured to similarly mediate communications from the processor subsystem 125 and the microprocessor 130 to the various devices 144, 145, 146 and 149. In particular, the UART preferably includes logic that allows for memory addressing wherein each of the peripheral devices has a memory address known to the UART, such as by using a hard coded memory map, that allows the UART to direct data from the microprocessor 130 and processor subsystem 125 to the various devices.

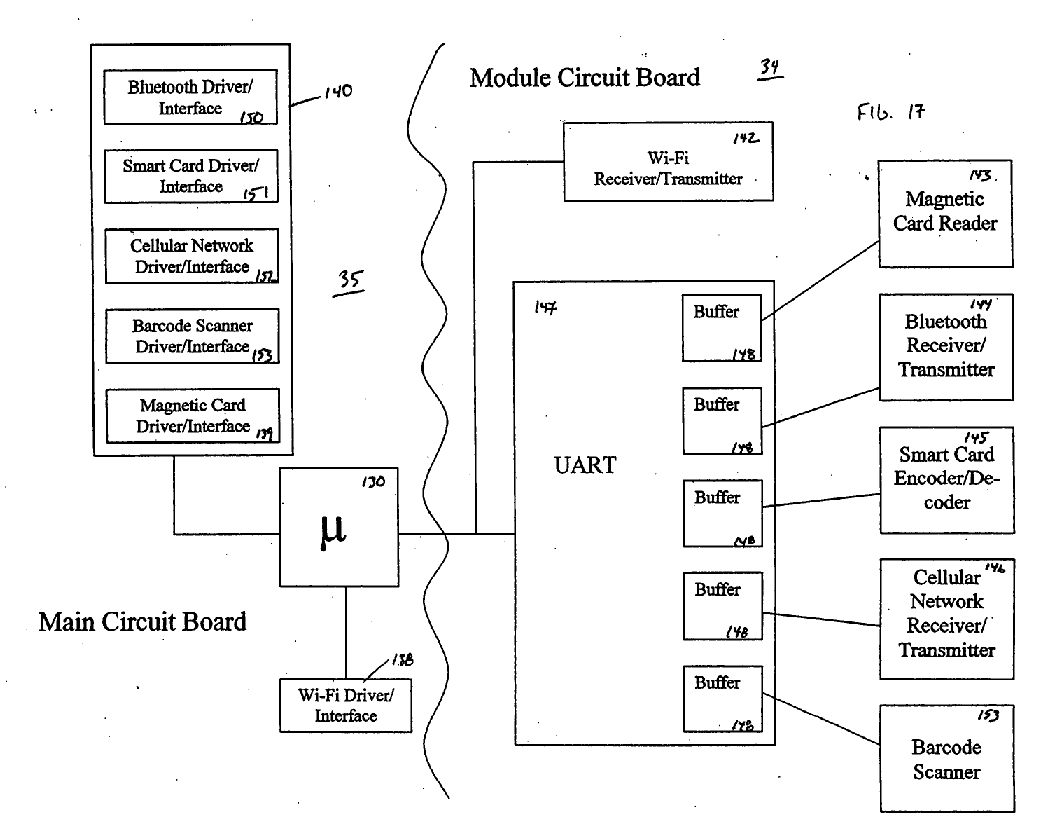

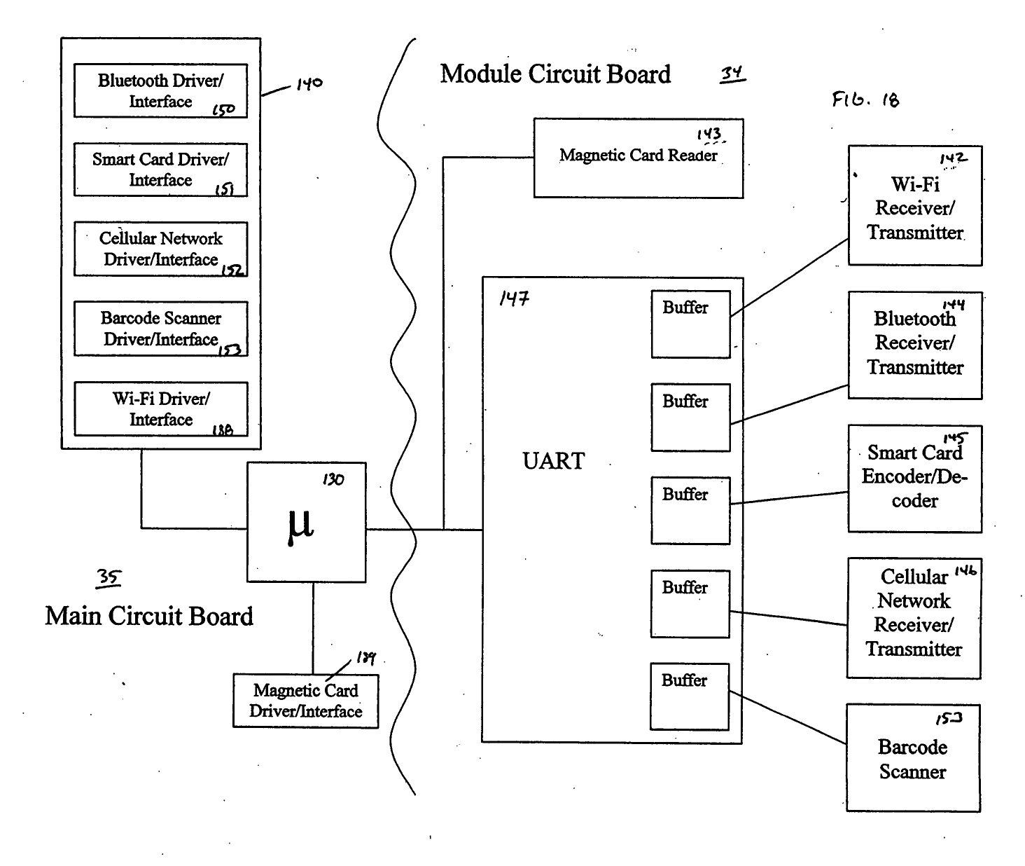

All of the devices 142, 143, 144, 145, 146 and 149 are enabled by the module circuit board 34 by expanding or changing the capabilities of the UART 147, if desired. But, for the embodiment illustrated in FIG. 16, the Wi-Fi receiver/transmitter 142 and the magnetic card reader 143 are not generally configured for a serial connection through the UART 147 and would be relatively bulky if adapted to do so. Customized modification of the Wi-Fi receiver/transmitter 142 and the magnetic card reader 143, however, could enable a compact connection via the UART 147 if desired. For example, FIGS. 17 and 18 illustrate different embodiments of the present invention wherein the UART 147 additionally enables communication of the magnetic card reader 143 and Wi-Fi receiver/transmitter 142, respectively.

In addition to the above-described combination of devices, the UART 147 can be adapted to coordinate communication from any number of peripheral devices not listed herein, including more or less than the four devices shown in FIG. 16. Advantageously, then, the printer 10 can be selectively equipped with several additional devices, including various layers of scanning, communications and other devices, to enable customized operation. These devices, for example, could include optical scanners, global positioning sensor, RFID encoder/reader, etc. It should be noted also, that the UART could be any collection of devices configured to accomplish the functional equivalent of the tasks described herein, such as a combination of memory modules and a multiplexer.

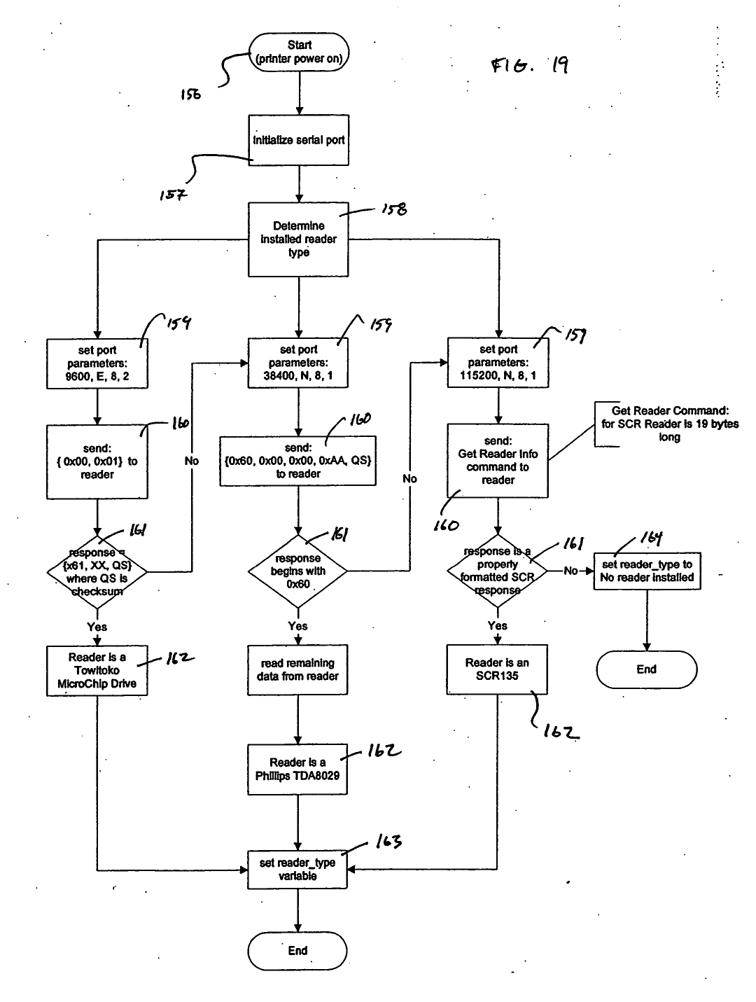

In another aspect, the smart card interface 151 includes logic configured to detect the type of smart card reader 143 that has been attached via the male and female connectors 37, 38 upon assembly and power up, as shown in FIG. 19. FIG. 19 includes a start or power on step 156, indicating powering on of the handheld printer 10, and a serial port initialization step 157. Subsequent to serial port initialization, a card reader type identification step 158 commences by proceeding down the leftmost branch of FIG. 19 to a step 159 for setting port parameters to values for one type of smart card reader 145, in this illustrative example a Towitoko MicroChip Drive, and then a step 160 sending a data array to the reader that is configured to engender a response from that type of reader. This could also be referred to as “pinging” the smart card reader 143.

Subsequent to the pinging step 160, the smart card interface 151 is configured to listen to the response by performing a checksum operation step 161 on the response. This step compares the checksum to a stored value that, if matched, proceeds to a step 162 that identifies the smart card reader 145 as the Towitoko MicroChip Drive (in this illustrative example). Once identified, a reader_type variable is set in a step 163. The reader_type variable can then be referenced in the future each time the processor subsystem 125 needs to determine how to format communications with that card type.

If the checksum does not match in step 161, the flow proceeds through the middle branch to another set port parameter step 159 which is configured to set the parameters for a second type of smart card reader 145, in this illustrative example a Phillips TDA8029 reader. The steps including the pinging step 160, the checksum operation 161, the type identification step 162 and the set reader_type variable step 163 are repeated for this type of card reader 145, and additional types of card readers, such as the SCR135 type card reader also illustrated as a type of card reader for a third branch in FIG. 19. Notably, any number of types of smart card reader, or other modular electronic devices, could be identified in this manner. Once the appropriate card reader type has been identified, then the reader_type variable is set in step 163 to that card type. If no type of smart card reader 145 can be identified (i.e., all cycles or branches have been compelted), then the process flow ends after a step 164 that sets the reader_type variable to “no reader installed.”

During operation, the UART 147 controls communications between the microprocessor and the various devices connected to the UART. Specifically, to transmit data from one of the devices connected to the UART 147 to the microprocessor 130, the UART initially stores the data in the buffer 148 associated with the device. The UART 147 next transmits an interrupt to the microprocessor 130 indicating that data is available. When the microprocessor reaches a point where it is ready to process the data, it retrieves the data from the UART buffer 148. In a like a manner, the microprocessor 130 may also send commands and data to the devices connected to the UART 147. This is, for example, done by transmission of an address associated with the device. Upon receipt, the UART determines from the address what device is to receive the commands and/or data and forwards it to the appropriate device.

While the UART 147 can be configured to transmit an interrupt to the microprocessor 130 each time data is received from one of the devices, this is not always done, as it may bog down operation of the processor. As such, the UART 147 may be configured so as to only send an interrupt either after a set number of data packets have been received from a device or on a give time cycle. For example, the UART may be configured to only send an interrupt when it has received five data packets from a device or to send data on a periodic cycle. The threshold for sending a data interrupt may be customized for each device connected thereto. For example, if the device is a wireless device capable of receiving and providing wireless data to the microprocessor, such as the Wi-Fi device 142, the Bluetooth device 144 or the cellular network device 146, the threshold may be set very low so that the device and microprocessor can communicate with little to no delay. However, if the device is the smart card reader 145, where data is only sent from the reader to the processor periodically, the threshold for sending an interrupt may be higher.

In this manner, the UART 147 acts as an intermediary between the microprocessor 130 and the devices connected thereto. The buffering function of the UART 147 allows the microprocessor 130 to receive data from each device on the microprocessor's time schedule. The microprocessor does not have to communicate with each device in real time, as the data from the devices is held in the buffers 148 until the microprocessor is ready to process the data.

Further, and importantly, because the UART 147 (in the illustrated example) is placed in the modular component cover 14, as opposed to the remainder of the housing 11, connection, wiring, and component count is reduced. Instead of each device on the module having dedicated wiring and components for interfacing with the microprocessor 130, the devices are connected to the UART 147, which communicates with the microprocessor via a common bus connection.

FIGS. 15-19 in the present application are block diagrams, flowcharts and control flow illustrations of methods, systems and program products according to the invention. It will be understood that each block or step of the block diagram, flowchart and control flow illustration, and combinations of blocks in the block diagram, flowchart and control flow illustration, can be implemented by computer program instructions. These computer program instructions may be loaded onto a computer or other programmable apparatus to produce a machine, such that the instructions which execute on the computer or other programmable apparatus create means for implementing the functions specified in the block diagram, flowchart or control flow block(s) or step(s).

These computer program instructions may also be stored in a computer-readable memory that can direct a computer or other programmable apparatus to function in a particular manner, such that the instructions stored in the computer-readable memory produce an article of manufacture including instruction means which implement the function specified in the block diagram, flowchart or control flow block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the block diagram, flowchart or control flow block(s) or step(s).

Accordingly, blocks or steps of the block diagram, flowchart or control flow illustration support combinations of means for performing the specified functions, combinations of steps for performing the specified functions and program instruction means for performing the specified functions. For example, FIG. 15 illustrates the Wi-Fi receiver/transmitter 142 which is configured to transmit and receive wireless local-area-network signals via the 802.11b standard and the barcode scanner 149 which is configured to optically recognize and decode barcodes, such as the barcode on an identification or transaction card. It will also be understood that each block or step of the block diagram, flowchart or control flow illustration, and combinations of blocks or steps in the block diagram, flowchart or control flow illustration, can be implemented by special purpose hardware-based computer systems which perform the specified functions or steps, or combinations of special purpose hardware and computer instructions.

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A printer assembly for printing on a printer media, said printer assembly comprising:
a print head configured to print on the printer media;
a media supply system configured to supply the printer media to the print head for printing thereon;
a processor assembly configured to operate printing functions, including functions of the print head and the media supply system;
a modular component assembly configured to receive at least an input-output device of a plurality of electronic components;
a modular component housing which receives the modular component assembly and includes an external surface presenting the input-output device for receiving input or presenting output; and
a main housing which contains the processor, the media supply and the print head, wherein said housings are configured to mate.

2. A printer assembly of claim 1, wherein the printer assembly includes a single connection configured to connect the processor with the modular component assembly.

3. A printer assembly of claim 2, wherein the processor includes a main circuit board supporting a portion of the connection and wherein the modular component assembly includes a module circuit board supporting another portion of the connection.

4. A printer assembly of claim 3, wherein the single connection is a multiple pin connector having male and female portions.

5. A printer assembly of claim 4, wherein the main circuit board is supported by the main housing and wherein the module circuit board is supported by the modular component housing.

6. A printer assembly of claim 5, wherein the circuit boards have a parallel orientation with respect to each other and the connector extends between the circuit boards.

7. A printer assembly of claim 5, wherein one of the circuit boards includes a UART configured to buffer and control information flow between the electronic device and the main circuit board.

8. A printer assembly of claim 7, wherein the modular component board includes the UART which is also contained in the modular component housing.

9. A printer assembly of claim 1, wherein the processor is configured to send a message to the electronic component and to perform a checksum operation on the response.

10. A printer assembly of claim 9, wherein the processor is configured to compare the checksum to stored values corresponding to the type of electronic component.

11. A printer assembly of claim 1, wherein the electronic components include any one of a group consisting of including a Wi-Fi device, a magnetic card reader, a Bluetooth device, a smart card device, a cellular network device, a barcode scanner and a RFID encoder/reader.

12. A handheld printer assembly comprising:
a housing including a base portion for supporting a core printer assembly wherein the core printer assembly includes a media support assembly, a drive assembly, a platen assembly, a print head assembly and a main circuit board,
wherein the media support assembly is configured to support a media supply roll, the drive and platen assemblies are configured to draw a strip of media off of the media supply roll and to hold the strip of media against the print head assembly and the print head assembly is configured to print on the strip of media as it is drawn against the print head,
wherein the main circuit board is configured to control the core printer assemblies and one or more modular electronic devices, including at least one input-output device, and
wherein the main circuit board includes one of a male or female module connector;
a modular component cover of the housing that supports a modular circuit board and the modular electronic devices, including an external surface presenting the input-output device for recording input or presenting output,
wherein the modular circuit board is configured to provide functional support for the modular electronic devices,
wherein the modular circuit board also includes another one of a male or female module connector, and
wherein the modular component cover also supports a UART that is configured to coordinate communications between the selected ones of the modular electronic devices with the main circuit board by communicating through the male and female module connectors.

13. A handheld printer assembly of claim 12, wherein the main circuit board includes a smart card function that is configured to determine a type of the smart card device connected thereto by communicating through the male and female module connectors.

14. A method of communicating with an electronic printer component, said method comprising:
operating printing functions, including printing on a media with a print head, with a processor supported by a main housing;
connecting the processor to at least an input-output device of a plurality of electronic components, said electronic components supported by a modular component assembly housing configured to mate with the main housing and having an external surface presenting the input-output device;
communicating with the input-output device presented by the external surface of the modular component housing;
receiving a response from the input-output device; and
processing the response to determine a type of the input-output device.

15. A method of claim 14, wherein connecting the processor includes connecting using a single connection.

16. A method of claim 15, wherein connecting includes connecting a main circuit board supporting the processor to a module circuit board supporting the input-output device.

17. A method of claim 16, wherein connecting includes connecting a male part of the connector to a female part of the connector.

18. A method of claim 17, wherein connecting also includes connecting the modular component housing containing the module circuit board to the main housing containing the main circuit board.

19. A method of claim 18, further comprising buffering information flow between the main circuit board and the electronic device.

20. A method of claim 14, wherein communicating with the electronic component includes sending a message to the electronic component and wherein processing the response includes performing a checksum operation on the response.

21. A method of claim 20, wherein processing the response further includes comparing the checksum to stored values corresponding to the type of electronic component.

22. A portion of a printer assembly for printing using a print head under control of a processor assembly, said print head and processing assembly contained in a main housing, said portion of said printer assembly comprising:
a modular component circuit board assembly configured to receive at least an input-output device of a plurality of electronic components and to connect in communication with the processor assembly; and
a modular component housing which is coupled to the modular component circuit board assembly and includes an external surface presenting the input-output device for recording input or presenting output communicated with the processor assembly and wherein said modular component housing configured to mate with the main housing.
